(19) United States
(12) Patent Application Publication
(10) Pub. No.: US 2005/0254373 A1
(43) Pub. Date: Nov. 17, 2005

(54) Method and apparatus for controlling data write-in speed in synchronization with the rotation of spindle in an optical drive

(75) Inventors: Jan Tang Wu, Taipei (TW); Wei Chung Wu, Taipei (TW)

Correspondence Address: BRUCE H. TROXELL, SUITE 1404, 5205 LEESBURG PIKE, FALLS CHURCH, VA, 22041, US

(73) Assignee: ALi Corporation

(21) Appl. No.: 11/000,073

(22) Filed: Dec. 1, 2004

(30) Foreign Application Priority Data
May 14, 2004 (TW) 93113581

(51) Int. Cl. G11B 5/09; G11B 7/09

(52) U.S. Cl. 369/47.21; 369/47.1; 369/53.2; 369/59.1

(57) ABSTRACT

A method and apparatus for controlling data write-in speed in synchronization with the rotation speed of spindle in an optical drive, c characterized in that a wobble signal generated while reading a blank optical disc is used for dynamically adjusting an ATIP signal (Absolute Time In Pregroove) of the optical disc generated while an optical pick-up head is writing data to the disc, referring as ATIP Sync signal hereinafter, so as to enable the ATIP Sync signal in synchronization with a Subcode Sync signal.

### FIELD OF THE INVENTION

The present invention relates to a method and apparatus for controlling data write-in speed in synchronization with the rotation speed of spindle in an optical drive, and more particularly, to a method and apparatus using a feedback control mechanism of wobble signal for synchronizing data write-in speed with the spindle rotation in an optical drive.

### BACKGROUND OF THE INVENTION

For a current Optical burner, different speeds of data write and spindle rotation velocity are required to be synchronized when a burning process is conducted so that the burning process may be assured to be performed in a correct and stable state and the difference of the two is limited within the specification of the burner.

In case of a typical CD-R/CD-RW burner that uses the wobble's ATIP Sync mark in synchronization with the Subcode Sync signal for relative positioning while burning an optical disc, the error of the synchronization is permitted to be in the range of +/−2 EFM (Eight to Fourteen Modulation). Wherein ATIP contains disc manufacturer id, disc writing characteristics and media capacity information, etc., That the abovementioned information are required fore enabling the drive to know what kind of disc it is writing to, and the Subcode Sync signal is an encoded subcode frame synchronization signal, in addition, EFM is a short for Eight to Fourteen Modulation.

However, there is no control mechanism provided for the synchronization between the speeds of the data write and the rotation speed of spindle in the currently existed optical burner, so that if there is a synchronization error between the ATIP Sync signal and the Subcode Sync signal exceeding the range of +/−2 EFM when a burning process is being performed in a CD-R/CD-RW burner, a difference of speeds of the data write and the motor rotation arises that results in a failure of the burning process.

In view of the above description, there is a need to provide a method and apparatus of controlling data write-in speed in synchronization with the rotation speed of spindle in an optical drive, by which the rotation speed of spindle is synchronized with the data write-in speed with respect to a feedback control of a CD-R/CD-RW burner, and simultaneously a synchronization error of the ATIP Sync and Subcode Sync signal ranged between +/−2 EFM is achieved.

### SUMMARY OF THE INVENTION

It is the primary object of the present invention to provide a method of controlling data write-in speed in synchronization with the rotation speed of spindle in an optical drive, characterized in that a wobble signal generated while reading a blank optical disc is used for dynamically adjusting an ATIP signal (Absolute Time In Pregroove) of the optical disc generated while an optical pick-up head is writing data to the disc, referring as ATIP Sync signal hereinafter, so as to enable the ATIP Sync signal in synchronization with a Subcode Sync signal.

To achieve the above object, the method using wobble signal to adjust ATIP Sync signal for controlling data write-in speed in synchronization with the rotation speed of spindle in an optical drive according to the invention comprises two paths. The first path according to the method of the invention is that: phase difference between ASYNC (ATIP Sync) signal and ESFS (Encode Subcode Frame Sync) signal is obtained to adjust an error between the wobble signal and a first reference signal corresponding to the wobble signal, thereby adjust the wobble signal through a feedback mechanism, wherein the phase difference is gain-amplified for fine-tuning the error. The second path according to the method of the invention is that: phase difference the phase difference between ASYNC signal and ESFS signal is obtained to adjust a first reference signal corresponding to a wobble signal and thereby control the wobble signal, wherein a second reference signal is generated with respect to the gain-modified phase difference and is based for compensating the first reference signal, i.e. adjusting the first reference signal.

It is another object of the present invention to provide an apparatus of controlling data write-in speed in synchronization with the rotation speed of spindle in an optical drive, comprising: a first phase detector, for detecting the phase difference between ASYNC signal and ESFS signal so as to output a phase error signal; a second phase detector; a speed detector; a gain amplifier, for receiving the phase error signal for gain-amplifying the same; and a controller, capable of receiving data from the speed detector and the second phase detector.

It is yet another object of the present invention to provide an apparatus of controlling data write-in speed in synchronization with the rotation speed of spindle in an optical drive, comprising: a phase detector, for detecting the phase difference between ASYNC signal and ESFS signal so as to output a phase error signal; a modifier, for receiving the phase error signal and outputting a modified phase error signal; a gain amplifier, for receiving the modified phase error signal and outputting an amplified modified phase error signal; and a synchronization signal generator, for receiving the amplified modified phase error signal and outputting a synchronization signal for compensating a reference signal received by the phase detector.

In summary, a method and apparatus of controlling data write-in speed in synchronization with the rotation speed of spindle in an optical drive uses a feedback control mechanism of wobble signal for synchronizing data write-in speed with the spindle rotation in an optical drive.

### BRIEF DESCRIPTION OF THE DRAWINGS

The invention will become more fully understood from the detailed description given hereinbelow illustration only, and thus are not limitative of the present invention, and wherein:

FIG. 1 is a schematic diagram showing an apparatus of controlling data write-in speed in synchronization with the rotation speed of spindle in an optical drive according to a preferred embodiment of the present invention;

FIG. 2 is a schematic diagram of timings occurred in controlling data write-in speed in synchronization with the rotation speed of spindle in an optical drive according to the preferred embodiment of the present invention; and

FIG. 3 is a schematic diagram of timings occurred while a protection mechanism of data write-in speed in synchronization with the rotation speed of spindle in an optical drive is in active according to the preferred embodiment of the present invention.

### DESCRIPTION OF THE PREFERRED EMBODIMENT

For your esteemed members of reviewing committee to further understand and recognize the fulfilled functions and structural characteristics of the invention, several preferable embodiments cooperating with detailed description are presented as the follows.

According to experiments and observations, in a optical disk drive, the frequency of wobble signal generated while reading an blank optical disc can be a multiple of the ASYNC signal used for determining whether the speed of data write and the rotation speed of spindle are synchronous, where the wobble signal is in fact has the frequency much higher than the frequency of the ASYNC signal. In view of this, the present invention uses a wobble signal generated while reading a blank optical disc to dynamically adjust an ASYNC signal by a feedback control mechanism so as to enable the ASYNC signal in synchronization with a Subcode Sync signal rapidly.

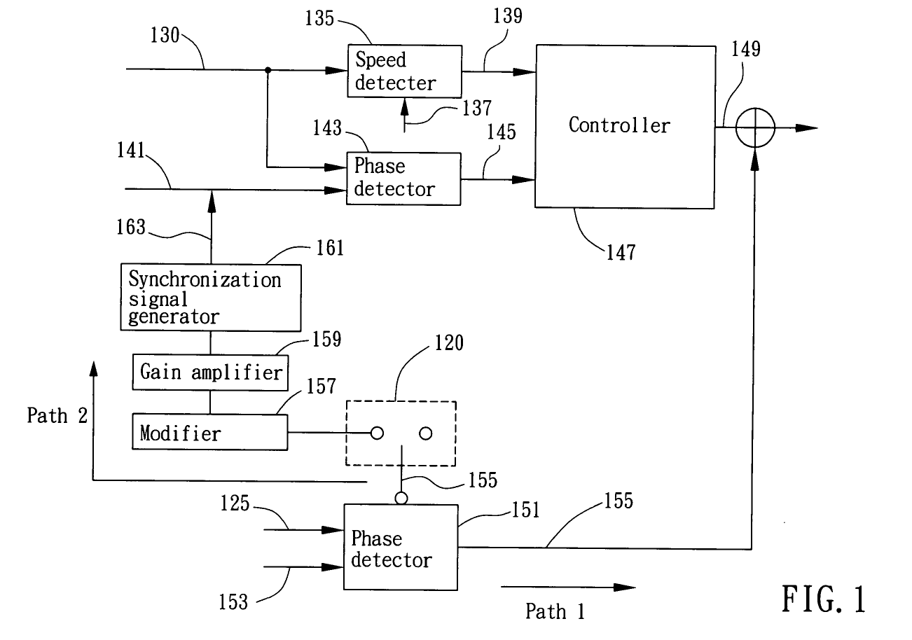

Referring to FIG. 1, a schematic diagram showing an apparatus of controlling data write-in speed in synchronization with the rotation speed of spindle in an optical drive according to a preferred embodiment of the present invention is illustrated therein. The wobble signal 130 intended to control the spindle of an optical disk drive is compared with an object value 137 in their frequencies through a speed detector 135 so as to output a frequency error signal 139. The same time that a reference signal 141 also intended to control the spindle is compared with the wobble signal in their phases so as to output a phase error signal 145. Thereafter, a controller 147 is provided to receive the frequency error signal 139 and the phase error signal 145 and make an evaluation basing on the two received error signals 139, 145 so as to output an error 149 as a reference to control the spindle by using a feedback control mechanism. As the spindle is controlled based on the error 149 to meet with a certain specification required by users, the frequency of the wobble signal 130 tracks the object value 137 and the reference signal 141. That is, a variation of the error 149 will indirectly vary the frequency of the wobble signal 130.

Therefore, as the path 1 shown in the FIG. 1, that is, when the wobble signal 130 has its frequency being a multiplication of the ASYNC signal 125 associated with the speeds of the data write and the rotation speed of the spindle and is used for dynamically adjusting the ASYNC signal 125, the error 149 outputted by the controller 147 is influenced by the phase error signal 155 generated by the phase detector 151 while comparing the ASYNC signal 125 and the subcode signal 153 so that the ASYNC signal 125 may be adjusted indirectly by adjusting the wobble signal 130. As is disclosed in the foregoing description, the present invention provides a first path 1, that is, the synchronization of the ASYNC signal 125 and the subcode signal 153 may be achieved through the path 1 by way of a feedback control mechanism with respect to the wobble signal 130.

As the path 2 shown in the FIG. 1, it is also possible to achieve the dynamic adjustment of the ASYNC signal 125 by way of a feedback control mechanism with respect to the wobble signal 130. Through the second path 2, the ASYNC signal 125 and the subcode signal 153 are compared at the phase detector 151 in their phases and a phase error signal 155 is thus outputted. The outputted phase error signal 155 is then passed on to a modifier 157 and a gain amplifier 159 and adjusted thereby. Then, the adjusted phase error signal enters a synchronization signal generator 161 enabling the generator 161 to output a reference signal 163 in response to the adjusted phase error signal. This reference signal 163 may compensate the phase error between the ASYNC signal 125 and the subcode signal 153 in another reference signal 141. Therefore, since the wobble signal 130 tracks the reference signal 141, such that the ASYNC signal 125 and the subcode signal 153 are synchronized, and the adjustment of the ASYNC signal 125 is well obtained through the feedback control mechanism with respect to the wobble signal 130.

Although the paths 1 and 2 are concurrently illustrated in the FIG. 1, only one of the paths 1, 2 may be used in a real implementation. Alternatively, the paths 1,2 may be both provided while an electronic switch 120 is also presented to make only one of the two paths 1,2 valid. It is to be noted that the paths 1,2 can not be valid at the same time since the wobble signal 130 and the reference signal 141 may, if both are valid simultaneously, fluctuate with the phase difference between the ASYNC signal 125 and the subcode signal 153 and thus the wobble signal 130 may not actually track the reference signal 141.

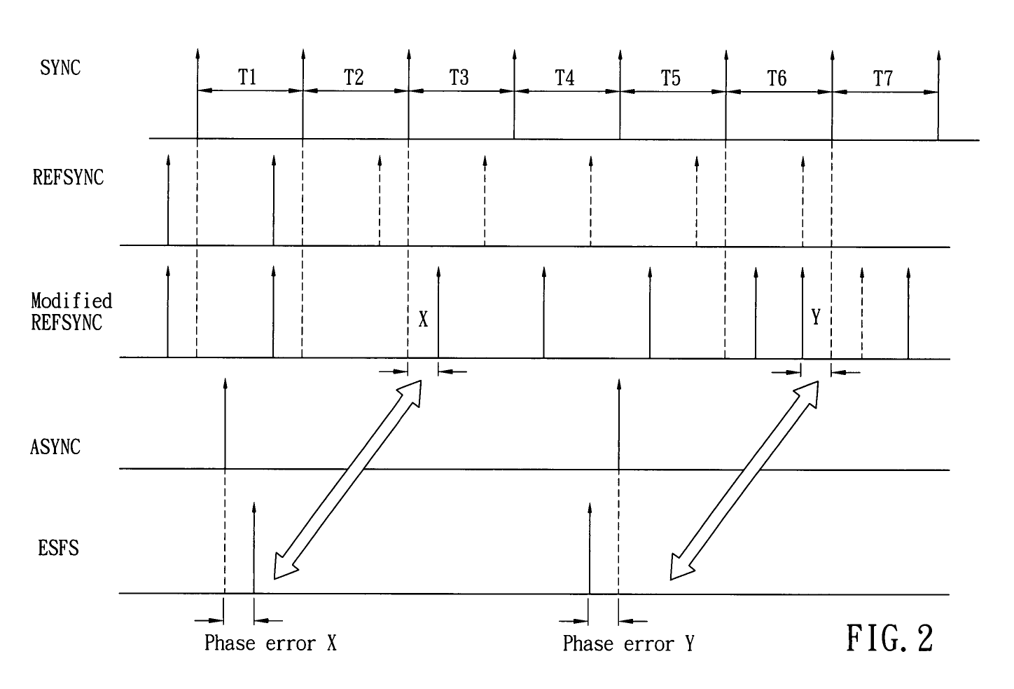

Referring to FIG. 2, a schematic diagram of timings occurred in controlling data write-in speed in synchronization with the rotation speed of spindle in an optical drive according to the preferred embodiment of the present invention is illustrated. When the ASYNC signal have a phase lead X with respect to the subcode signal, the reference signal corresponding to the wobble signal may be modified to have a delay corresponding to a phase lag X, which is the same phase amount as the phase lead X. As such, the wobble signal may track the modified reference signal so that the ASYNC signal may be correspondingly delayed with this phase difference X.

Oppositely, when the ASYNC signal has a phase lag Y with respect to the subcode signal, the original reference signal corresponding to the wobble signal may be modified to have a phase lead Y so that the ASYNC signal may be correspondingly provided with a phase lead Y.

To prevent the ASYNC signal from poorly received or missing caused by the scratch of an optical disc or a improper detection of the wobble signal while a burning process is in process in an optical disk drive, the present invention provides a protection mechanism for protecting the ASYNC signal from being erroneously controlled through the abovementioned feedback control mechanism, in which the wobble signal is being used for controlling the ASYNC signal through the feedback control mechanism while the ASYNC signal has an exceeding amount of the phase lag or phase lead of the subcode signal.

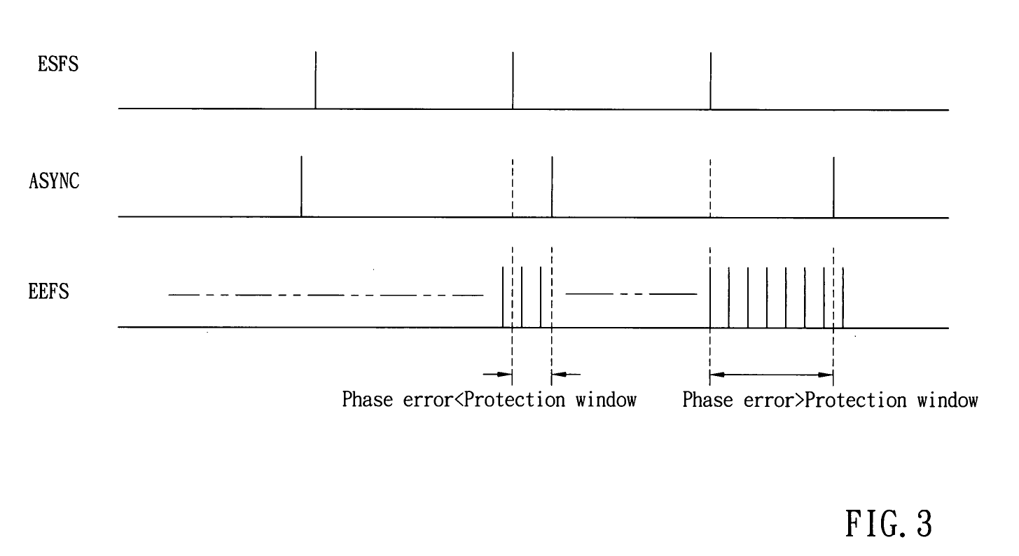

Referring to FIG. 3, which is a schematic diagram of timings occurred while a protection mechanism of data write-in speed in synchronization with the rotation speed of spindle in an optical drive is in active according to the preferred embodiment of the present invention. As shown in FIG. 3, a protection window is provided with respect to the phases of the ASYNC signal and the subcode signal. If the phase difference between the ASYNC signal and the subcode signal exceeds a range specified by the protection window, the mechanism for protection of the ASYNC signal is disabled. Otherwise, the mechanism for protection of the ASYNC signal is enabled. For example, if the protection window is set as corresponded to 4 EFM, a phase lag of 2 EFM of the ASYNC signal over the subcode signal is taken as permitted according to the specified protection window and the mechanism for protection is enabled. In case of a phase lag of 6.5 EFM, the mechanism for protection is disabled.

In this manner, the mechanism for protection provides the advantage that if a poor wobble signal presents, the recording operation corresponding thereto may be stopped and a renewal recording operation may be launched after reducing the speed of the motor rotation. In this case, since the recording operation is not coerced to be stopped, the recording may not fail where the recording operation may proceed normally or the recorded data may be read normally.

In conclusion, the present invention discloses a method and apparatus of controlling data write-in speed in synchronization with the rotation speed of spindle in an optical drive which is achieved through a feedback control mechanism with respect to the wobble signal to assure a stably operated burning process. Through the feedback control mechanism with respect to the wobble signal (44.1 kHz), the synchronization of the speeds of the data write and the rotation speed of spindle may be obtained in a rapid manner which is much faster than the feedback control mechanism where the phase difference between the ASYNC signal (75 Hz) and the subcode signal is relied on to achieve the adjustment of the ASYNC signal. In this manner, there is an additional advantage that the disc may have more spaces spared for recording. In addition, the protection mechanism makes possible for all burning processes to be successfully performed and for the data written into the disc to be readable.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

1. A method for controlling data write-in speed in synchronization with the rotation speed of spindle in an optical drive, comprising the step of:
dynamically adjusting an ATIP signal (Absolute Time In Pregroove) of the optical disc generated while an optical pick-up head of the optical drive is writing data to an optical disc by using a wobble signal generated while reading a blank optical disc, referring as ATIP Sync (ASYNC) signal hereinafter, so as to enable the ATIP Sync signal in synchronization with a Subcode Sync signal.

2. The method as recited in claim 1, further comprising the step of:
adjusting an error between the wobble signal and a first reference signal corresponding to the wobble signal with respect to a comparison between the ATIP Sync signal and the Subcode Sync signal, thereby adjust the wobble signal through a feedback mechanism.

3. The method as recited in claim 2, further comprising the step of:
obtaining a phase difference between the ASYNC signal and the Subcode Sync signal as the comparison.

4. The method as recited in claim 3, further comprising:
gain-amplifying the phase difference for adjusting the phase error.

5. The method as recited in claim 1, further comprising:
adjusting a first reference signal corresponding to the wobble signal and thereby controlling the wobble signal with respect to a comparison between the ATIP Sync signal and the Subcode Sync signal.

6. The method as recited in claim 5, further comprising:
obtaining a phase difference between the ASYNC signal and the Subcode Sync signal as the comparison.

7. The method as recited in claim 6, further comprising:
modifying the phase difference for adjusting the first reference signal.

8. The method as recited in claim 7, further comprising:
gain-amplifying the modified phase difference for adjusting the first reference signal.

9. The method as recited in claim 8, further comprising:
generating a second reference signal in response to the amplified/modified phase difference to compensate for and adjust the first reference signal.

10. The method as recited in claim 1, further comprising the step of:
stopping the adjusting of the ASYNC signal by the wobble signal while a phase difference of the ASYNC signal and the Subcode Sync signal exceeds a specific range; and
adjusting the ASYNC signal by the wobble signal while the phase difference of the ASYNC signal and the Subcode Sync signal falls into the specific range.

11. The method as recited in claim 10, wherein the specific range is within 2 EFM.

12. An apparatus for controlling data write-in speed in synchronization with the rotation speed of spindle in an optical drive, comprising:
a first phase detector, for detecting a phase difference between a ASYNC signal and a Subcode Sync signal so as to output a phase error signal;
a second phase detector;
a speed detector;
a gain amplifier, for receiving the phase error signal and gain-amplifying the same as output thereof; and
a controller, capable of receiving outputs of the speed detector and the second phase detector.

13. An apparatus for controlling data write-in speed in synchronization with the rotation speed of spindle in an optical drive, comprising:
a phase detector, for detecting a phase difference between a ASYNC signal and a Subcode Sync signal so as to output a phase error signal;
a modifier, for receiving the phase error signal and modifying the same as output thereof;
a gain amplifier, for receiving the modified phase error signal and gain-amplifying the same as output thereof; and
a synchronization signal generator, for receiving the amplified/modified phase error signal to generate a synchronization signal for compensating a reference signal received by the phase detector.
